(19) United States
(12) Patent Application Publication
(10) Pub. No.: US 2026/0146006 A1
(43) Pub. Date: May 28, 2026

(54) METHOD OF PROCESSING GREEN TAPE CERAMIC MATERIAL TO FORM CERAMIC RIBBON AND BATTERY COMPRISING THE CERAMIC MATERIAL OF THE RIBBON

(71) Applicant: CORNING INCORPORATED, CORNING, NY (US)

(72) Inventors: Abner Farrales Bello, Phoenix, AZ (US); Joseph Henry Citriniti, Corning, NY (US); Philip Robert LeBlanc, Corning, NY (US)

(21) Appl. No.: 19/120,353

(22) PCT Filed: Oct. 31, 2023
(86) PCT No.: PCT/US2023/036413

§ 371 Date: Apr. 11, 2025

Related U.S. Application Data
(60) Provisional application No. 63/423,094, filed on Nov. 7, 2022.

(51) Int. Cl. C04B 35/64; C04B 41/00; H01M 10/0525

(52) U.S. Cl. CPC C04B 35/64; C04B 41/0036; C04B 41/0072; C04B 41/009; H01M 10/0525; C04B 2235/6025; C04B 2235/665; C04B 2235/94

(57) ABSTRACT

Various aspects of the present disclosure relate to a method of processing a ceramic substrate. The method includes providing a green-tape ceramic material. The green-tape ceramic material is passed through an oven (102) to form a ceramic ribbon. A parameter of the ceramic ribbon, such as thickness or surface texture, is monitored by an attribute measurement apparatus (114), such as an infrared scanner. Finally, a portion of the ceramic ribbon is exposed to a heat source (112), such as a laser beam. The portion of the ceramic ribbon is exposed to the heat source for an amount of time sufficient to correct a defect in the portion of the ceramic ribbon.

### CROSS-REFERENCE TO RELATED APPLICATIONS

This application claims the benefit of priority under 35 U.S.C. § 119 of U.S. Provisional Application No. 63/423,094 filed Nov. 7, 2022, the content of which is incorporated herein by reference in its entirety.

### BACKGROUND

For a variety of applications, the close control of the thickness and surface shape of manufactured substrates can be important, if not critical. Thermo-mechanical and flow conditions can be uneven across the entirety or portions of a width of a ceramic ribbon as it is being formed. Although the variations may be only a few microns in size, the consequences of such variations can be significant. It is therefore desirable to develop methods to control the thickness and surface shape of the substrates.

### SUMMARY OF THE DISCLOSURE

Various aspects of the present disclosure relate to a method of processing a ceramic substrate. The method includes providing a green-tape ceramic material. The green-tape ceramic material is passed through an oven to form a ceramic ribbon. A parameter of the ceramic ribbon is monitored. Finally, a portion of the ceramic ribbon is exposed to a heat source. The portion of the ceramic ribbon is exposed to the heat source for an amount of time sufficient to correct a defect in the portion of the ceramic ribbon.

### BRIEF DESCRIPTION OF THE FIGURES

The drawings illustrate generally, by way of example, but not by way of limitation, various aspects of the present invention.

FIG. 1 is a schematic diagram showing system for producing a ceramic ribbon.

### DETAILED DESCRIPTION OF THE DISCLOSURE

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than or equal to about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

A tape casting process can include a ceramic ribbon passing through a drying oven and ultimately, an annealing oven. Because of variation (along the ceramic ribbon length and across the ceramic ribbon width) in the thickness of the ceramic ribbon, the water concentration, and other factors, applied stresses during the heating cycles can be uneven and so the final ceramic ribbon shape can feature bow and warp. Also, a factor resulting in residual shape is uneven heating inside the ovens themselves due to, among other effects, discrete heating elements, separate temperature control zones, and convection currents. Improvements have focused on increasing process uniformity (composition, thickness, oven design, etc.) but there may be a practical limit to this as well as diminishing returns (e.g. decreasing heating element size in the ovens). As ceramic ribbon thicknesses decrease and process speeds increase, delivering a consistently flat shape will become more difficult. It follows that it can be the case in the production of a substrate such as a ceramic substrate for example that a parameter such as a thickness, texture, or both of the substrate that is produced is non-uniform. The non-uniformity can be localized, in which case the non-uniformity would be present only at a somewhat discrete portion of the substrate as viewed across the width of the substrate. On the other hand, a plurality of non-uniformities can exist, even in some cases across the entire width of the substrate.

It usually is the case in the production of a substrate, such as a ceramic substrate for example, that particular parameter non-uniformities in the substrate, if not corrected, will continue to be manifested as the substrate is continued to be produced. This can be particularly undesirable if the ceramic ribbon is intended to be used as a component of a battery such as a lithium ion battery.

According to one aspect of the present disclosure, these parameter non-uniformities are identified and preselected for attention so that the non-uniformities can be essentially eliminated in the subsequently produced substrate. The correction of the thickness and/or shape non-uniformities is accomplished by increasing the temperature to homogenize the densification process during sintering of the portions of the substrate at which the non-uniformities are present. As a result, the respective thickness or surface shape defect of each non-uniform portion of the substrate is made uniform in the subsequently produced substrate as described in greater detail below.

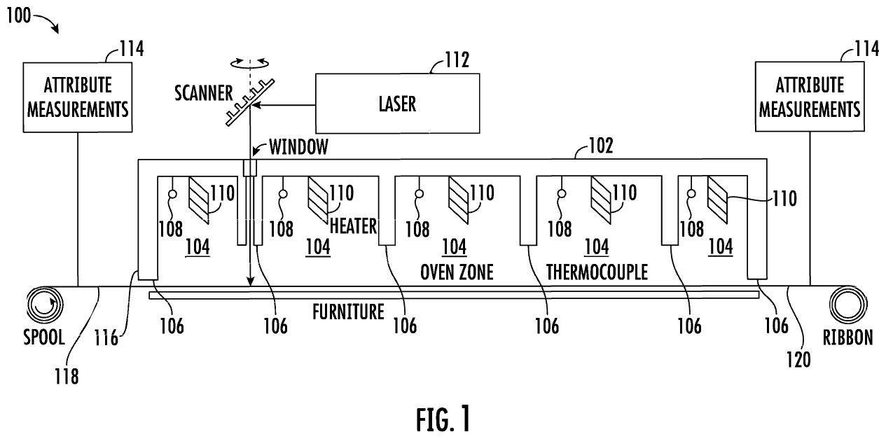

FIG. 1 is a schematic diagram showing system 100 for producing a ceramic ribbon. System 100 includes oven 102. Oven 102 includes a plurality of regions 104 defined, in part, by baffles 106. Although five regions 104 are shown, it is possible for other examples of oven 102 to include any other plural number of regions 104 or a single region 104. Each region 104 includes a respective thermocouple 108 and heater 110. Heat source 112 is disposed within oven 102. Heat source 112 is a laser. Although heat source 112 is shown located within oven 102, it is possible for heat source 112 being located external to oven 102. Additionally, it is within the scope of the instant disclosure for a plural number of heat sources 112 being associated with oven 102. System 100 also includes attribute measurement apparatus 114. As shown, a first attribute measurement apparatus 114 is located at an entrance to oven 102 and a second attribute measurement apparatus 114 is located at an exit to oven 102. Attribute measurement apparatus 114 can be an infrared scanner.

Turning back to heat source 112, it includes a laser generator that is configured to generate and emit a laser beam adequate to increase the temperature and affect the consolidation phase of the sintering process of at least one preselected portion of a ceramic substrate, such as the ceramic ribbon in a furnace for example, when the laser beam is directed onto the at least one preselected portion of the ceramic substrate during sintering and thereby alter the densification pattern of at least one preselected portion of the ceramic substrate.

The adequacy of a laser beam for the purpose of increasing the temperature and altering the densification of at least one preselected portion of a ceramic ribbon is a function primarily of the characteristics of the ceramic ribbon in a sintering process, the wavelength and the power level of the laser beam and whether an objective is to alter the thickness or shape of a limited or a large number of preselected portions of the ceramic substrate. For example, according to one aspect, where the ceramic substrate comprises a single layer, the wavelength of the laser beam is selected so that the laser beam is substantially absorbed by the ceramic substrate and does not readily pass through the ceramic substrate. According to another aspect, for example, if the thickness or shape of only a single portion of a few millimeters of a single layer of the ceramic substrate is to be controlled and the laser beam is relatively stationary and fixed on the single portion of the ceramic substrate in a sintered state, the power of the laser beam can be lower than the power used if the thicknesses of a plurality of portions of the ceramic substrate are to be controlled and the laser beam must continuously and rapidly sweep over the plurality of portions. Additionally, if the cycle rate of the laser is greater than approximately 50 Hz or so, the laser can be pulsed or continuous.

The laser generator, as an example, can include a high-intensity infrared laser generator such as a carbon dioxide (CO₂) laser generator of a type that is available from numerous commercial sources. The wavelengths of the light produced and the power generated by CO₂ laser generators are variable and can be selected so that the laser beam generated is adequate to increase the temperature of at least one preselected portion of a ceramic substrate, such as the ceramic ribbon, sufficiently to correct thickness or shape variations present in the ceramic substrate. For example, a laser beam with a wavelength of between about 0.200 micrometers to about 100 micrometers, about 5 micrometers to about 50 micrometers, about 5 micrometers to about 15 micrometers, less than, equal to, or greater than about 0.2000 micrometers, 5, 10, 15, 20, 25, 30, 35, 40, 45, 50, 55, 60, 65, 70, 75, 80, 85, 90, 95, or about 100 micrometers and a power output of thousands of watts can be suitable for increasing the temperature of at least one preselected portion of a ceramic substrate such as the ceramic ribbon. However, because differing ceramic substrates will absorb laser beams to differing degrees at differing wavelengths, wavelengths outside the range of about 0.200 micrometers to about 100 micrometers can be employed.

The control apparatus can also include a reflecting apparatus that is configured to receive from the laser generator and reflect onto at least one preselected portion of the ceramic substrate, such as the ceramic ribbon for example, the laser beam generated and emitted by the laser generator. The reflecting apparatus can therefore function as a beam-steering and/or scanning device.

The reflecting surface in one example can include a gold-coated mirror although other types of mirrors may be used in other examples. Gold-coated mirrors may be desirable under certain applications for the purpose of providing superior and consistent reflectivity with respect to infrared lasers. In addition, the reflectivity of the gold-coated mirrors is virtually independent of the angle of incidence, and, therefore, the gold-coated mirrors are particularly useful as scanning or laser beam-steering mirrors.

The reflecting apparatus can include a regulating mechanism configured to adjust an attitude of the reflecting surface of the reflecting apparatus with respect to the receipt of the laser beam and a location of the at least one preselected portion of the ceramic substrate, such as the ceramic ribbon for example. Thereby, the laser beam can be reflected as reflected laser beams from the reflecting surface onto the at least one preselected portion of the ceramic substrate. According to one example, the regulating mechanism can comprise a galvanometer that is operatively associated with the reflecting surface so that the reflecting surface can be rotated by the galvanometer along an axis in relation to the ceramic ribbon. For example, the reflecting surface can be mounted on a rotating shaft that is driven by a galvanometer motor and rotated about axis.

Based on the foregoing description, it will be understood that, according to one aspect, a method is provided of controlling a thickness of at least one preselected portion of a substrate, such as a ceramic ribbon for example. The method can include generating a laser beam and directing the laser beam onto the at least one preselected portion of the substrate (e.g., green state). The thickness of the at least one portion of the substrate is not fixed. The laser beam possesses adequate energy to increase a temperature of the at least one preselected portion of the substrate sufficiently to alter the thickness or shape of the at least one preselected portion of the substrate. Consequently, the at least one preselected portion of the substrate can be dynamically adjusted to attain a desired thickness or shape.

According to another aspect, the step of directing the laser beam onto the at least one preselected portion of the substrate includes directing the laser beam from a laser beam generator, at which the laser beam is generated, to a reflecting surface from which the laser beam is reflected to the at least one preselected portion of the substrate in a sintered state. In both these aspects, the laser beam can be directed onto a plurality of preselected portions of the substrate and the plurality of preselected portions of the substrate can be arranged across an entire width of the substrate, for example with respect to the ceramic ribbon. In addition, as an example, the residence time of the laser beam at each of the plurality of preselected portions of the substrate can be selectively controlled. In examples of all these aspects, the substrate can include a ceramic ribbon produced in a horizontal, continuous-sintered forming process such as the ceramic ribbon.

A laser power control unit controls the operation of the laser generator so that the wavelength and the power of the laser beam generated at the laser generator will comprise preselected values. In addition, the laser power control unit can control the time intervals during which the laser generator generates the laser beam. In turn, a control computer is provided to appropriately control the operation of the laser power control unit whereby the laser power control unit will cause the laser generator to generate during preselected time intervals a laser beam having preselected wavelength and power characteristics. At the same time, the control computer can be operatively associated with the reflecting apparatus so as to control the functioning of the regulating mechanism, and in a particular example where a galvanometer is employed, the motor of the galvanometer. Accordingly, the control computer is capable of adjusting the attitude and positioning of the reflecting surface with respect to the receipt of the laser beam by the reflecting surface and the locations of the preselected portions of the ceramic substrate for which the thicknesses are to be controlled.

The non-uniformities in thickness and shape that can occur in connection with the production of substrates such as the ceramic ribbon for example can arise in various contexts. For example, a non-uniformity can be present at a single localized portion of the substrate and that non-uniformity can exist with respect to the thicknesses of adjacent portions of the substrate or with respect to the single localized portion of the substrate itself. In either event, it is only necessary to provide for the reflecting apparatus to continuously reflect to that single portion of the substrate the laser beam at a suitable energy level and wavelength for the purpose of causing the thickness or shape of the single portion of the substrate to attain a desired thickness or shape in the finally produced substrate. This is accomplished by altering the consolidation levels locally of the ceramic substrate during the sintering process through local temperature increase. This is accomplished by programming the computer to cause the regulating mechanism of the reflecting apparatus to control the attitude and positioning of the reflecting surface of the regulating mechanism and to cause the power control unit to control the energy level and wavelength of the laser beam produced by the laser generator. By way of further example, there can exist in the substrate two or more distinct portions in which thickness or shape non-uniformities exist. In that case, the computer can be programmed so as to cause the regulating mechanism of the reflecting apparatus to control the attitude and positioning of the reflecting surface such that the reflected beam continuously is placed in contact with the two or more portions of the substrate at which the non-uniformities exist. Also, the computer is programmed to cause the power control unit to control the energy level and wavelength of the laser beam produced by the laser generator so that the thicknesses or shape at those two or more portions are caused to be altered whereby they attain respective desired thicknesses or flatness in the finally produced substrate. In addition, the computer can be programmed so as to cause the reflected beam, through the operation of the regulating mechanism, to reside at each of the two or more non-uniform portions of the substrate for the necessary periods of time to adequately alter the consolidation of each of the portions so that the thickness and flatness of the non-uniform portions can be suitably altered. Also by way of example, the non-uniformities in thickness that are present in the substrate can range across the entirety of the substrate, including any thickness or shape marks from the tape-casting process are present in the ceramic ribbon. Again, the computer can be programmed appropriately to cause the laser generator, through the control of the power control unit, to provide a laser beam of an appropriate strength and wavelength and to cause the laser beam, through the instrumentality of the reflecting apparatus, to continuously sweep back and forth across the substrate while residing at the portions of the substrate at which the thickness or shape corrections are to be made for the periods of time required to alter the consolidation levels of these portions of substrate to levels that result in the attainment of the respective desired thickness or shape at these portions of the substrate as the substrate is produced.

The development of the information and data required to appropriately program the computer can be accomplished in various ways. For example, a thickness or shape measurement trace can be carried out on the substrate that has been produced for the purpose of identifying thickness or shape non-uniformities that are present in the substrate. The computer can then be programmed appropriately based on that measurement trace. Also by way of example, the thickness or shape profile of the substrate can be monitored in real time as the substrate is produced and the information developed by that monitoring can be fed back to the computer so that the computer, pursuant to an appropriate closed-loop control algorithm, can cause adjustments to the reflecting apparatus and the laser power control unit to cause the portions of the substrate that exhibit thickness or shape non-uniformities to attain the desired thickness and shape.

The computer that controls the aspects of the laser mentioned herein also communicates with attribute measurement apparatus 114. Communication with attribute measurement apparatus 114 can allow the computer to determine measurements of the green state ceramic ribbon, as well as the measurements of the annealed ceramic ribbon exiting oven 102. Those acquired measurements can then be compared to a physical model stored in the computer or a module in communication with the module. If the comparison indicates that corrective action must be taken the computer can activate the laser as described above. In some aspects the computer may be further capable of adjusting the properties of heaters 104.

The discussion above related to the use of the laser to adjust the thickness of the ceramic ribbon, however, it is also within the scope of the disclosure for the laser to also impart a desired texture (e.g., surface profile) to the ceramic ribbon. Additionally, the laser can be used to impart a visual image in the ceramic ribbon. Examples of visual images include a mark, a word, a number, a code, or a combination thereof would mark the product according to time or distance or any other information based on the control system. For example, visual images could include small visible dot matrix characters at the edge of the ceramic ribbon that could indicate position, time, green tape source, or any other relevant information. In another example, marks could be made at set distances (e.g., every 260 mm, which is the length of a typical part that gets snapped from the roll). In another example, a small dot could marked next to a known defect in the green tape, as detected and measured in the control system. In another example, marks can be made in positions where laser heating was done. A visual image can also not be visible to the naked eye, but may become visual upon exposure to a blacklight, UV light, or the like. A visual image may also not be visual to the naked eye but may be visible or readable to a machine.

It is believed that there are several non-limiting advantages to using the method described herein to form ceramic ribbons. For example the ceramic ribbons formed tend to have a more uniform flatness, have lower mechanical stresses, be processed faster through the ovens (e.g., due to the non-uniformities being dynamically corrected), the desired final form of the ceramic ribbons can be more consistently achieved, a wider range of ceramic materials can be used that may otherwise be difficult to control and achieve uniform properties such as thickness and shape, additionally higher yields of ceramic ribbons can be achieved as less “defective” product is produced.

### Exemplary Aspects

The following exemplary aspects are provided, the numbering of which is not to be construed as designating levels of importance:

Aspect 1 provides a method of processing a ceramic substrate, the method comprising:

providing a green-tape ceramic material;

passing the green-tape ceramic material through an oven and forming a ceramic ribbon;

monitoring a parameter of the ceramic ribbon; and

exposing a portion of the ceramic ribbon to a heat source, wherein the portion of the ceramic ribbon is exposed to the heat source for an amount of time sufficient to correct a defect in the portion of the ceramic ribbon.

Aspect 2 provides the method of Aspect 1, wherein the oven comprises a plurality of regions created by a plurality of baffles.

Aspect 3 provides the method of any one of Aspects 1 or 2, wherein the heat source comprises a quartz lamp, a light emitting diode, a laser beam, a wire heater, or a combination thereof.

Aspect 4 provides the method of Aspect 3, wherein the heat source comprises a laser beam that is directed from a laser beam generator.

Aspect 5 provides the method of Aspect 4, wherein the laser beam generator is located within the oven.

Aspect 6 provides the method of Aspect 4, wherein the laser beam generator is located externally with respect to the oven.

Aspect 7 provides the method of any one of Aspects 4-6, wherein the laser beam is directed to a reflecting surface from which the laser beam is reflected to the portion of the ceramic ribbon.

Aspect 8 provides the method of any one of Aspects 1-7, further comprising exposing a second portion of the ceramic ribbon to a second laser beam.

Aspect 9 provides the method of any one of Aspects 1-8, wherein the ceramic material comprises a metal oxide.

Aspect 10 provides the method of any one of Aspects 1-9, the method comprising:

measuring the parameter of the ceramic ribbon;

comparing the measured parameter to a physical model to determine whether a defect is present in the ceramic ribbon; and

activating the heat source if a defect is detected.

Aspect 11 provides the method of Aspect 10, wherein the parameter of the ceramic ribbon is measured with an infrared detector.

Aspect 12 provides the method of any one of Aspects 1-11, wherein the parameter of the ceramic ribbon is at least one of:

a thickness of the ceramic ribbon measured between a first major surface and a second major surface of the ceramic ribbon; and

a texture of a first major surface, a second major surface, an edge connecting the first major surface and the second major surface, or a combination thereof.

Aspect 13 provides the method of any one of Aspects 1-12, further comprising generating a visual image in the ceramic ribbon with the heat source.

Aspect 14 provides the method of Aspect 13, wherein the visual image comprises a mark, a word, a number, a code, or a combination thereof.

Aspect 15 provides a method of processing a ceramic substrate, the method comprising:

providing a green-tape ceramic material, the ceramic material comprising a metal oxide;

passing the green-tape ceramic material through an oven and forming a ceramic ribbon;

measuring a parameter of the ceramic ribbon;

comparing the measured parameter to a physical model to determine whether a defect is present in the ceramic ribbon; and

exposing a portion of the ceramic ribbon to a laser beam, wherein the portion of the ceramic ribbon is exposed to the laser beam for an amount of time sufficient to correct a defect in the portion of the ceramic ribbon.

Aspect 16 provides the method of Aspect 15, wherein the heat source comprises a laser beam that is directed from a laser beam generator.

Aspect 17 provides the method of Aspect of Aspect 16, wherein the laser beam generator is located within the oven.

Aspect 18 provides the method of any one of Aspects 16 or 17, wherein the laser beam generator is located externally with respect to the oven.

Aspect 19 provides the method of any one of Aspects 15-18, wherein the parameter of the ceramic ribbon is measured with an infrared detector.

Aspect 20 provides the method of any one of Aspects 15-19, wherein the parameter of the ceramic ribbon comprises:

a thickness of the ceramic ribbon measured between a first major surface and a second major surface of the ceramic ribbon; and

a texture of a first major surface, a second major surface, an edge connecting the first major surface and the second major surface, or a combination thereof.

Aspect 21 provides the method of any one of Aspects 1-20, further comprising generating a visual image in the ceramic ribbon with the heat source.

Aspect 22 provides the method of Aspect 21, wherein the visual image comprises a mark, a word, a number, a code, or a combination thereof.

Aspect 23 provides a ceramic ribbon formed according to the method any one of Aspects 1-22.

Aspect 24 provides a battery comprising the ceramic material of any one of Aspects 1-23.

Aspect 25 provides the battery of Aspect 24, wherein the battery is a lithium ion battery.

The terms and expressions that have been employed are used as terms of description and not of limitation, and there is no intention in the use of such terms and expressions of excluding any equivalents of the features shown and described or portions thereof, but it is recognized that various modifications are possible within the scope of the aspects of the present invention. Thus, it should be understood that although the present invention has been specifically disclosed by specific aspects and optional features, modification and variation of the concepts herein disclosed may be resorted to by those of ordinary skill in the art, and that such modifications and variations are considered to be within the scope of aspects of the present invention.

1. A method of processing a ceramic substrate, the method comprising:
providing a green-tape ceramic material;
passing the green-tape ceramic material through an oven and forming a ceramic ribbon;
monitoring a parameter of the ceramic ribbon; and
exposing a portion of the ceramic ribbon to a heat source, wherein the portion of the ceramic ribbon is exposed to the heat source for an amount of time sufficient to correct a defect in the portion of the ceramic ribbon.

2. The method of claim 1, wherein the oven comprises a plurality of regions created by a plurality of baffles.

3. The method of claim 1, wherein the heat source comprises a quartz lamp, a light emitting diode, a laser beam, a wire heater, or a combination thereof.

4. The method of claim 3, wherein the heat source comprises a laser beam that is directed from a laser beam generator.

5. The method of claim 4, wherein the laser beam generator is located within the oven.

6. The method of claim 4, wherein the laser beam generator is located externally with respect to the oven.

7. The method of claim 4, wherein the laser beam is directed to a reflecting surface from which the laser beam is reflected to the portion of the ceramic ribbon.

8. The method of claim 1, further comprising exposing a second portion of the ceramic ribbon to a second laser beam.

9. The method of claim 1, wherein the ceramic material comprises a metal oxide.

10. The method of claim 1, the method comprising:
measuring the parameter of the ceramic ribbon;
comparing the measured parameter to a physical model to determine whether a defect is present in the ceramic ribbon; and
activating the heat source if a defect is detected.

11. The method of claim 10, wherein the parameter of the ceramic ribbon is measured with an infrared detector.

12. The method of claim 1, wherein the parameter of the ceramic ribbon is at least one of:
a thickness of the ceramic ribbon measured between a first major surface and a second major surface of the ceramic ribbon; and
a texture of a first major surface, a second major surface, an edge connecting the first major surface and the second major surface, or a combination thereof.

13. The method of claim 1, further comprising generating a visual image in the ceramic ribbon with the heat source.

14. The method of claim 13, wherein the visual image comprises a mark, a word, a number, a code, or a combination thereof.

15. A method of processing a ceramic substrate, the method comprising:
providing a green-tape ceramic material, the ceramic material comprising a metal oxide;
passing the green-tape ceramic material through an oven and forming a ceramic ribbon;
measuring a parameter of the ceramic ribbon;
comparing the measured parameter to a physical model to determine whether a defect is present in the ceramic ribbon; and
exposing a portion of the ceramic ribbon to a laser beam, wherein the portion of the ceramic ribbon is exposed to the laser beam for an amount of time sufficient to correct a defect in the portion of the ceramic ribbon.

16. The method of claim 15, wherein the heat source comprises a laser beam that is directed from a laser beam generator.

17. The method of claim of claim 16, wherein the laser beam generator is located within the oven.

18. The method of claim 16, wherein the laser beam generator is located externally with respect to the oven.

19. The method of claim 15, wherein the parameter of the ceramic ribbon is measured with an infrared detector.

20. The method of claim 15, wherein the parameter of the ceramic ribbon comprises:
a thickness of the ceramic ribbon measured between a first major surface and a second major surface of the ceramic ribbon; and
a texture of a first major surface, a second major surface, an edge connecting the first major surface and the second major surface, or a combination thereof.

21. The method of claim 1, further comprising generating a visual image in the ceramic ribbon with the heat source.

22. The method of claim 21, wherein the visual image comprises a mark, a word, a number, a code, or a combination thereof.

23. A ceramic ribbon formed according to the method of claim 1.

24. A battery comprising the ceramic material of claim 1.

25. The battery of claim 24, wherein the battery is a lithium ion battery.
